(19) United States
(12) Patent Application Publication
(10) Pub. No.: US 2024/0098843 A1
(43) Pub. Date: Mar. 21, 2024

(54) MULTICAST RADIO BEARER CONFIGURATION INFORMATION

(71) Applicant: QUALCOMM Incorporated, San Diego, CA (US)

(72) Inventors: Prasad Reddy KADIRI, San Diego, CA (US); Alberto RICO ALVARINO, San Diego, CA (US); Umesh PHUYAL, San Diego, CA (US); Le LIU, San Jose, CA (US); Xipeng ZHU, San Diego, CA (US); Miguel GRIOT, La Jolla, CA (US); Haris ZISIMOPOULOS, London (GB); Masato KITAZOE, Hachiouji-shi (JP); Kazuki TAKEDA, Minato-ku (JP); Dario Serafino TONESI, San Diego, CA (US)

(21) Appl. No.: 18/262,368

(22) PCT Filed: Mar. 4, 2022
(86) PCT No.: PCT/US2022/070974

§ 371 Date: Jul. 20, 2023

(30) Foreign Application Priority Data
Mar. 30, 2021 (GR) 20210100206

(51) Int. Cl. H04W 76/40; H04W 76/27

(52) U.S. Cl. CPC H04W 76/40; H04W 76/27

(57) ABSTRACT

Various aspects of the present disclosure generally relate to wireless communication. In some aspects, a user equipment (UE) may receive, via a first cell, multicast radio bearer (MRB) configuration information indicating one or more MRB configurations for receiving multicast communications. The UE may receive, via a second cell, a multicast communication based at least in part on an MRB configuration of the one or more MRB configurations. Numerous other aspects are described.

### CROSS-REFERENCE TO RELATED APPLICATION

This Patent application claims priority to Greece Patent Application No. 20210100206, filed on Mar. 30, 2021, entitled “MULTICAST RADIO BEARER CONFIGURATION INFORMATION,” which is hereby expressly incorporated by reference herein.

### FIELD OF THE DISCLOSURE

Aspects of the present disclosure generally relate to wireless communication and to techniques and apparatuses for multicast radio bearer configuration information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, via a first cell, multicast radio bearer (MRB) configuration information indicating one or more MRB configurations for receiving multicast communications; and receiving, via a second cell, a multicast communication based at least in part on an MRB configuration of the one or more MRB configurations.

In some aspects, a UE for wireless communication includes a memory; and one or more processors, coupled to the memory, configured to: receive, via a first cell, MRB configuration information indicating one or more MRB configurations for receiving multicast communications; and receive, via a second cell, a multicast communication based at least in part on an MRB configuration of the one or more MRB configurations.

In some aspects, a non-transitory computer-readable medium storing a set of instructions for wireless communication includes one or more instructions that, when executed by one or more processors of a UE, cause the UE to: receive, via a first cell, MRB configuration information indicating one or more MRB configurations for receiving multicast communications; and receive, via a second cell, a multicast communication based at least in part on an MRB configuration of the one or more MRB configurations.

In some aspects, an apparatus for wireless communication includes means for receiving, via a first cell, MRB configuration information indicating one or more MRB configurations for receiving multicast communications; and means for receiving, via a second cell, a multicast communication based at least in part on an MRB configuration of the one or more MRB configurations.

In some aspects, a method of wireless communication performed by a base station includes transmitting MRB configuration information indicating one or more MRB configurations for receiving multicast communications within a multicast area associated with a set of multiple cells; and transmitting, to one or more additional base stations associated with the multicast area, an indication to establish a multicast broadcast service (MBS) based at least in part on a UE associated with the MBS entering an inactive state.

In some aspects, a base station for wireless communication includes a memory; and one or more processors, coupled to the memory, configured to: transmit MRB configuration information indicating one or more MRB configurations for receiving multicast communications within a multicast area associated with a set of multiple cells; and transmit, to one or more additional base stations associated with the multicast area, an indication to establish an MBS based at least in part on a UE associated with the MBS entering an inactive state.

In some aspects, a non-transitory computer-readable medium storing a set of instructions for wireless communication includes one or more instructions that, when executed by one or more processors of a base station, cause the base station to: transmit MRB configuration information indicating one or more MRB configurations for receiving multicast communications within a multicast area associated with a set of multiple cells; and transmit, to one or more additional base stations associated with the multicast area, an indication to establish an MBS based at least in part on a UE associated with the MBS entering an inactive state.

In some aspects, an apparatus for wireless communication includes means for transmitting MRB configuration information indicating one or more MRB configurations for receiving multicast communications within a multicast area associated with a set of multiple cells; and means for transmitting, to one or more additional base stations associated with the multicast area, an indication to establish an MBS based at least in part on a UE associated with the MBS entering an inactive state.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antenna, RF chains, power amplifiers, modulators, buffer, processor(s), interleaver, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of multicast areas and a broadcast area, in accordance with the present disclosure.

FIG. 4 is a diagram illustrating an example associated with multicast radio bearer configuration information, in accordance with the present disclosure.

FIGS. 5 and 6 are diagrams illustrating example processes associated with multicast radio bearer configuration information, in accordance with the present disclosure.

FIGS. 7 and 8 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

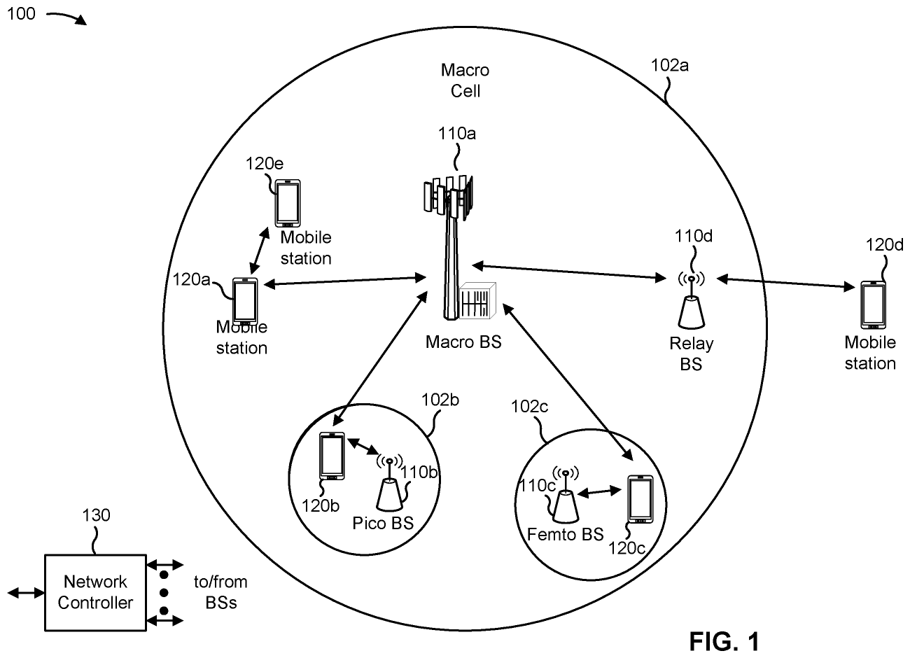

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

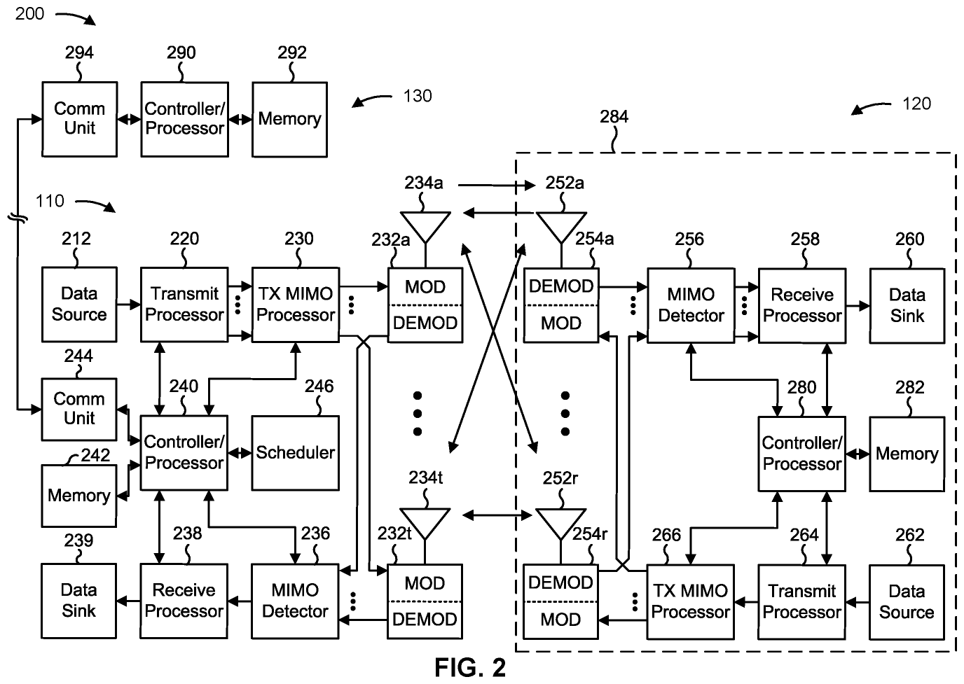

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

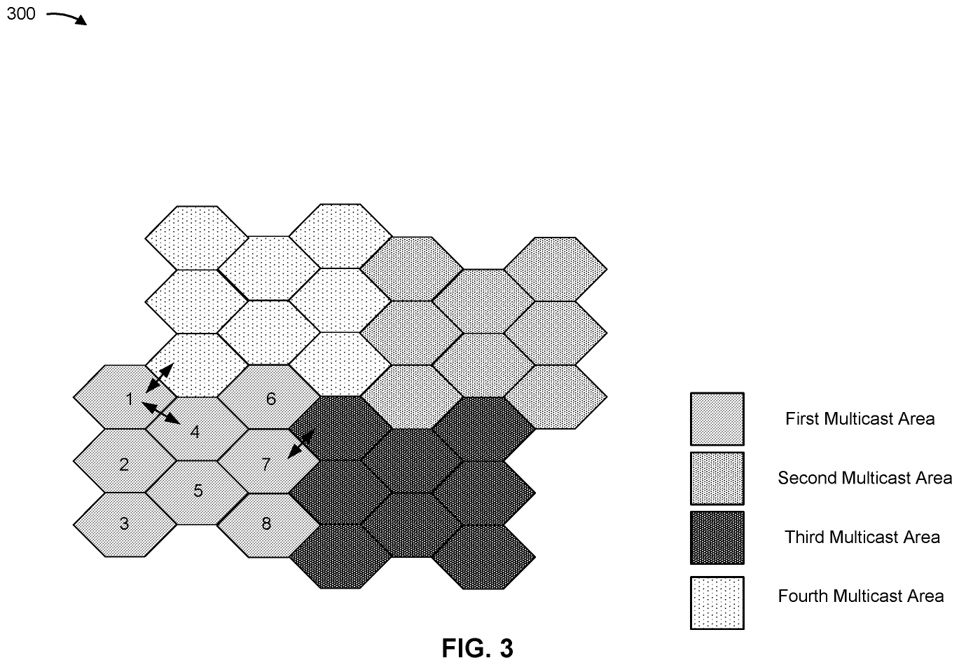

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3-6.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3-6.

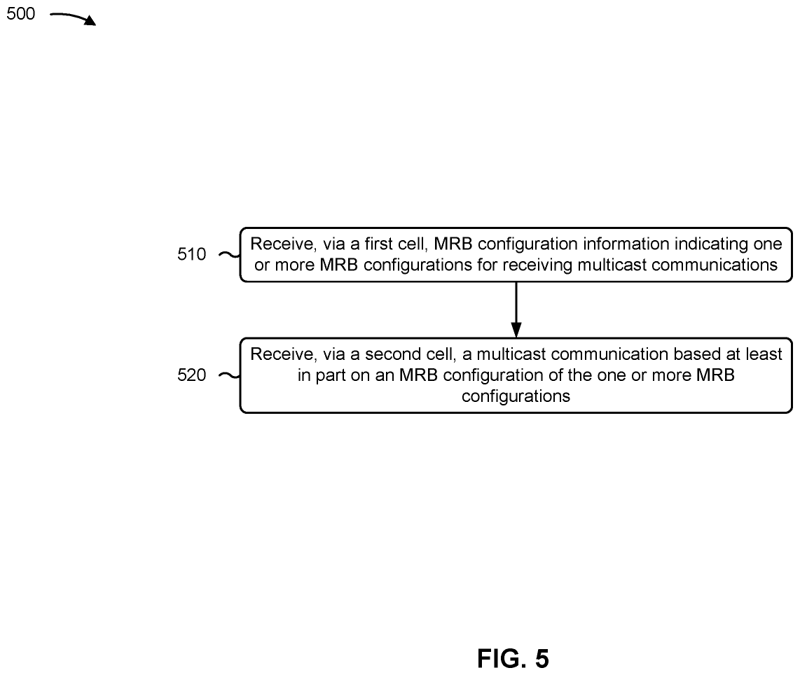

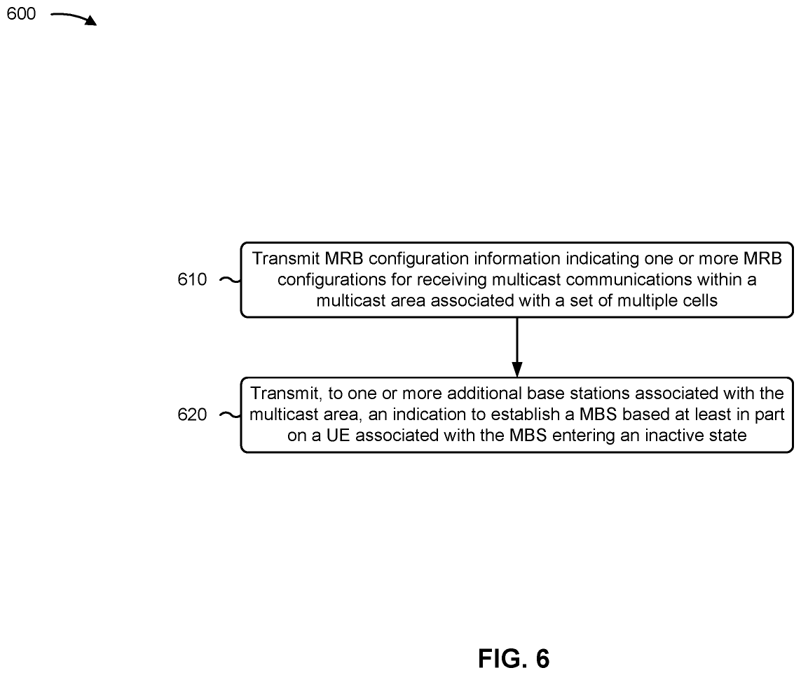

Controller/processor 240 of base station 110, controller/processor 280 of UE 120, and/or any other component(s) of FIG. 2 may perform one or more techniques associated with multicast radio bearer configuration information, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some aspects, executing instructions may include running the instructions, converting the instructions, compiling the instructions, and/or interpreting the instructions, among other examples.

In some aspects, the UE includes means for receiving, via a first cell, MRB configuration information indicating one or more MRB configurations for receiving multicast communications; or means for receiving, via a second cell, a multicast communication based at least in part on an MRB configuration of the one or more MRB configurations. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the base station includes means for transmitting MRB configuration information indicating one or more MRB configurations for receiving multicast communications within a multicast area associated with a set of multiple cells; or means for transmitting, to one or more additional base stations associated with the multicast area, an indication to establish an MBS based at least in part on a UE associated with the MBS entering an inactive state. The means for the base station to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

FIG. 3 is a diagram illustrating an example 300 of multicast areas and a broadcast area, in accordance with the present disclosure. Each of the multicast areas (e.g., a multicast radio access network (RAN) areas) may be associated with a set of one or more cells. For example, a first multicast area may include cells 1-8. In some aspects, a multicast area may include a subset of cells within a RAN area, may include all cells of a RAN area, and/or may include cells of a system information block (SIB) area, among other examples. The RAN may track UEs at a multicast area level (e.g., may track the UE by multicast area without tracking by cell) when UEs are in inactive modes. In some aspects, a multicast area may be configurable (e.g., based at least in part on congestion, cell sizes, and/or proximity to other multicast areas, among other examples). In some aspects, the multicast area may be independent from, or configured independently from, a broadcast area.

The broadcast area may include one or more multicast areas, portions of the one or more multicast areas, and/or may overlap with at least a portion of one of the one or more multicast areas.

In a broadcast area, a UE may receive a broadcast service when configured in different radio resource control (RRC) states. For example, the UE may receive broadcast signaling when the UE is configured in an RRC idle state, an RRC inactive state, or in an RRC connected state. In some aspects, any UE within the broadcast area may receive the broadcast service without joining a broadcast session. Base stations within the broadcast area may transmit SIBs and broadcast control channel (e.g., a multicast control channel (MCCH)) communications to provide control information associated with the broadcast service. The UE may not provide layer 1 (L1) or layer 2 (L2) feedback based at least in part on the UE receiving the broadcast service without establishing an associated uplink channel.

The UE may receive a multicast service based at least in part on joining a multicast session (e.g., via a non-access stratum (NAS) session management procedure). For example, the UE may join the multicast session when the UE has an RRC connection with a base station of the multicast area. In some aspects, the base station may provide the multicast service based at least in part on the base station having established a multicast broadcast service (MBS) session with core network (e.g., based at least in part on the base stations having joined a multicast tree). In some networks, the base station may establish the MBS session based at least in part on the UE, connected with the base station via a cell provided by the base station, joining a multicast session associated with the MBS. In some networks, the base station may establish the MBS session based at least in part on the UE, having already joined the multicast session, being handed over from a neighbor cell.

In some aspects, a UE may continue to receive the multicast service after entering an inactive state (e.g., RRC inactive state). For example, the base station may move the UE to the inactive state based at least in part on network congestion and/or on an amount of available computing resources of the base station. However, in some networks without multicast areas, the UE may be required to resume an RRC connection based at least in part on the UE being handed over to a neighbor cell. This may be based at least in part on the neighbor cell not yet having established the MBS (e.g., based at least in part on not having any UEs within the neighbor cell that have joined the multicast session) and/or based at least in part on the UE not receiving an indication of an MRB configuration associated with the neighbor cell. This may consume computing, power, network, and/or communication resources to request an RRC connection with the neighbor cell and to establish the RRC connection with the neighbor cell.

In some aspects described herein, the UE may receive, from a first cell, MRB configuration information indicating one or more MRB configurations (e.g., associated with the first cell and a second cell) for receiving multicast communications within a multicast area. The UE may enter an RRC inactive state before leaving the first cell and entering the second cell. The UE may receive an indication that the second cell uses an MRB configuration, of the one or more MRB configurations, and receiving a multicast communication via the second cell based at least in part on the MRB configuration. In this way, the UE may conserve computing, power, network, and/or communication resources that may have otherwise been used to request an RRC connection with the neighbor cell and to establish the RRC connection with the neighbor cell.

In some aspects, the base station may transmit dedicated RRC signaling of multicast configuration information (e.g., an RRC reconfiguration message or an RRC release message, among other examples) and an SIB to indicate configurations for the UE to use for receiving a multicast service while in an RRC inactive state. In some aspects, the base station may transmit the multicast configuration information to the UE before the UE enters an RRC inactive state. When the UE enters a second cell (e.g., a neighbor cell), the UE may receive an SIB that indicates a multicast configuration to use for reception of the multicast service within the second cell. For example, the SIB may indicate a multicast radio access network identification (e.g. an identifier) that is associated with the multicast configuration. All cells within the multicast area may use a multicast configuration indicated in the multicast configuration information. In some aspects, all cells within the multicast area may use a same multicast configuration. In some aspects, cells may remove, add, or change identifiers based at least in part on updates to a multicast configuration and/or updates to multicast services supported by the cells.

In some examples, a UE may receive the multicast configuration information (e.g., a set of multicast configurations) while in a connection state (e.g., RRC connected state). The multicast configuration information may identify multicast configurations based on identifiers (e.g., IDs). A base station to which the UE is connected may release the UE to an inactive state (e.g., based at least in part on congestion of an associated cell). The UE may move to a neighbor cell while in the inactive state (e.g., using idle cell reselection) and acquire an SIB of the neighbor cell. The SIB of the neighbor cell may include an identifier and/or a multicast area identifier. The UE may determine if the neighbor cell is associated with the multicast configuration information (e.g., based at least in part on the multicast area identifier matching a multicast area of the multicast configuration information and/or a multicast area of the base station) and, if associated with the multicast configuration information, which multicast configuration to use for receiving the multicast service in the neighbor cell. If the UE determines that the neighbor cell is not associated with the multicast communication, or if the identifier does not match an identifier within the multicast communication information, the UE may resume an RRC connection to receive an updated multicast configuration for the neighbor cell. In some aspects, the UE may resume the RRC connection based at least in part on radio channel conditions (e.g., RSRP, RSRQ, and/or signal-to interference plus noise (SINR) metrics satisfying a threshold).

In some aspects, one or more multicast configurations (e.g., MRB configurations) may be used for only UEs in inactive states or may be used for UEs in active states and inactive states (e.g., regardless of an RRC state).

In some aspects, one or more base stations in the multicast area may transmit a group paging to alert UEs to resume RRC connections to receive a multicast service. In some aspects, UEs that are in an inactive state (e.g., RRC Inactive) may resume RRC connections to receive the multicast configuration information (e.g., MRB configuration information). If a UE is in an inactive state and receives the group paging, and the UE has previously received the multicast configuration information, the UE may resume the RRC connection and a base station to which the UE connects may determine whether to keep the UE in a connected state or to release to an inactive state to continue receiving the multicast service. Alternatively, the UE may determine (e.g., via base station signaling) that the UE is configured to receive the multicast service while in an inactive state and may continue receiving the multicast service without resuming the RRC connection. If the UE is in the inactive state and receives the group paging, and the UE has not yet received the multicast configuration information, the UE may resume the RRC connection to receive the multicast configuration information, and the base station may determine whether to keep the UE in a connected state or to release to an inactive state to continue receiving the multicast service.

In some aspects, a UE may receive an SIB that indicates whether multicast configuration information is to be transmitted via an MCCH communication or via dedicated RRC signaling. The UE may receive the multicast configuration information based at least in part on reading the MCCH communication. The MCCH communication may use a same MCCH as a broadcast MCCH or may use a multicast MCCH (e.g., the multicast service may use an MCCH that is different from an MCCH that is used by the broadcast service). In some aspects, the MCCH may be a multicast area-based MCCH, where the UE may not be required to acquire the MCCH to obtain an MRB configuration when the UE moves to a neighbor cell (e.g., during idle cell reselection). In some aspects, the UE, when in an idle stat, may receive an indication (e.g., a page) that the MCCH has changed. The indication may be based at least in part on a physical downlink control channel (PDCCH) downlink control information (DCI) and may indicate a same radio network temporary identification (RNTI) for both broadcast services and multicast services, or the DCI can use different RNTIs to differentiate between control information for the broadcast services and control information for the multicast services.

In some aspects, all base stations with a multicast area may establish (e.g., join) an MBS based at least in part on a UE entering an inactive state within the multicast area. For example, if the UE enters the inactive state within a first cell of the multicast area, a base station of the first cell may transmit an indication, to other base stations of the multicast area, to establish an MBS. In some aspects, the base station may transmit the indication using a core network solution. For example, the base station may notify an access and mobility management function (AMF) entity that the UE receiving a multicast service has entered an inactive state. The base station may indicate the multicast area associated with the base station. The AMF entity may initiate a MBS session resource setup with one or more base stations of the multicast area. In some aspects, the one or more base stations may include all base stations in the multicast area or a subset of base stations within the multicast area. The subset of base stations may be based at least in part on the subset of base stations being derived based at least in part on mobility prediction of the UE and/or based at least in part on the subset of base stations being within a notification area of the multicast area.

In some aspects, the base station may transmit the indication via a base station to base station link, such as an Xn interface. In some aspects, receiving base stations may transmit a request to the core network for the MBS session resource setup. In some aspects, the base station may transmit the indication to all base stations within the multicast area or a subset of base stations within the multicast area, as described herein.

As indicated above, FIG. 3 is provided as an example. Other examples may differ from what is described with regard to FIG. 3.

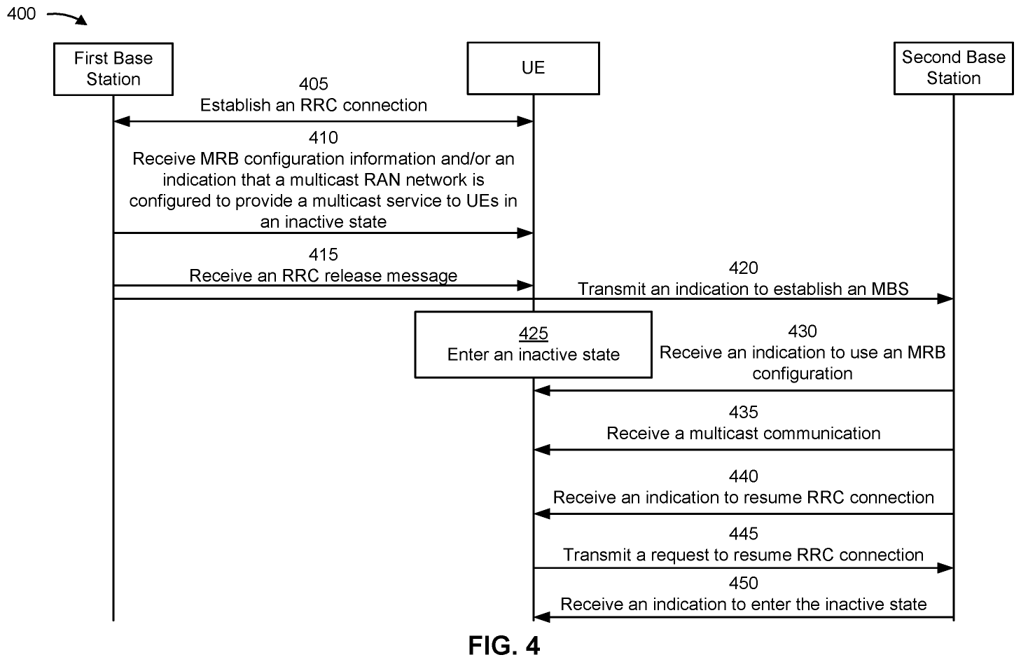

FIG. 4 is a diagram illustrating an example 400 associated with multicast radio bearer configuration information, in accordance with the present disclosure. As shown in FIG. 4, a first base station (e.g., base station 110), a second base station (e.g., base station 110), and a UE (e.g., UE 120) may communicate with one another via one or more cells of a radio access network.

As shown by reference number 405, the UE may establish an RRC connection with the first base station. In some aspects, the UE may be configured to communicate using a multicast service provided by the first base station. In some aspects, the UE may be configured to perform one or more operations described herein.

As shown by reference number 410, the UE may receive, and the base station may transmit, MRB configuration information and/or may receive an indication that a multicast RAN network is configured to provide a multicast service to UEs in an inactive state. In some aspects, the UE may receive the MRB configuration information via MCCH signaling (e.g., as control signaling), an RRC reconfiguration message (e.g., received during communication in an active state), or an RRC release message. In some aspects, the UE may receive the MRB configuration information based at least in part on receiving the RRC release message and having an established session (e.g., an ongoing session) with the multicast service.

The MRB configuration information may indicate one or more MRB configurations for receiving multicast communications within a multicast area. The one or more MRB configurations may be associated with different cells of the multicast area. In some aspects, the MRB configuration may be associated with receiving multicast communications only when in an inactive state, or the MRB configuration may be associated with receiving multicast communications within the multicast area regardless of an activity state (e.g., RRC connected, RRC idle, or RRC inactive).

In some aspects, the UE may receive the indication that the multicast RAN network is configured to provide multicast services to UEs in the inactive state in a same message as the MRB configuration information. For example, reception of the MRB configuration information may implicitly indicate support for UEs to receive the multicast services in the inactive state. In some aspects, the UE may receive the indication that the multicast RAN network is configured to provide multicast services to UEs in the inactive state in a separate RRC message.

As shown by reference number 415, the UE may receive, and the first base station may transmit, an RRC release message. In some aspects, the first base station may indicate MRB configuration information within, or in addition to, the RRC release message. For example, the first base station may provide the MRB configuration information when releasing the UE into an inactive state so the UE can continue to receive multicast communications while in the inactive state.

As shown by reference number 420, the first base station may transmit, and the second base station may receive, an indication to establish an MBS. In some aspects, the first base station may transmit the indication to establish the MBS to one or more base stations with a same multicast area as the first base station. In some aspects, the first base station may transmit the indication based at least in part on transmitting the RRC release message to the UE. In this way, the second base station may provide the multicast communications to the UE if the UE enters a cell associated with the second base station.

In some aspects, the first base station may transmit the indication via a network entity (e.g., the AMF entity) that may modify the indication and/or forward the indication to the second base station and one or more additional base stations. In some aspects, the base station may select the one or more additional base stations and the second base station based at least in part on being within the same multicast area and/or based at least in part on being within an expected mobility area of the UE. In some aspects, the first base station may include an indication of the multicast area to the network entity and the network entity may identify, based at least in part on the indication of the multicast area the one or more additional base stations and the second base station for forwarding the indication.

In some aspects, the first base station may transmit the indication via a base station to base station link. For example, the first base station may transmit the indication using an Xn protocol to directly, or via a mesh-type network, provide the indication to the base station without transmitting the indication via an associated core network. The second base station and the one or more additional base stations may request that the core network initiate a MBS session resource setup associated with the multicast setup based at least in part on reception of the indication.

As shown by reference number 425, the UE may enter an inactive state (e.g., an RRC inactive state). In some aspects, the UE may enter the inactive state based at least in part on receiving the RRC release message, or in absence of receiving the RRC release message. For example, the UE may have entered the inactive state prior to entering the cell associated with the first base station.

As shown by reference number 430, the UE may receive, and the second base station may transmit, an indication to use an MRB configuration for receiving a multicast communication. In some aspects, the UE may receive the indication via SIB and/or via MCCH signaling. In some aspects, the indication may indicate that a cell associated with the second base station uses an MRB configuration associated with the MRB configuration information (e.g., whether the cell associated with the second base station is within the multicast area and/or whether the MRB configuration is indicated with the MRB configuration information).

In some aspects, the MRB configuration may be a different MRB configuration used for receiving the multicast communication via the cell associated with the first base station. In some aspects, the MRB configuration may be a same MRB configuration used for receiving the multicast communication via the cell associated with the first base station.

As shown by reference number 435, the UE may receive, and the second base station may transmit, a multicast communication. In some aspects, the UE may receive the multicast communication based at least in part on the MRB configuration (e.g., the MRB configuration indicated in connection with reference number 430). In some aspects, the UE may receive the multicast communication via the second cell without first resuming an RRC connection in the second cell. In some aspects, the UE may first resume the RRC connection in the second cell based at least in part on a determination that the MRB configuration is not indicated within the MRB configuration information.

As shown by reference number 440, the UE may receive, and the second base station may transmit, an indication to resume an RRC connection. In some aspects, the second base station may transmit the indication to resume the RRC connection for the UE to receive the MRB configuration information. In some aspects, the indication may include a page message. In some aspects, the indication may include an indication of a version of the MRB configuration information that the UE may use to determine if the UE has already received the MRB configuration information.

In some aspects, the UE may be configured to decide whether to resume the RRC connection based at least in part on whether the UE has already received the MRB configuration information. In some aspects, the UE is configured to request to resume the RRC connection even if the UE has already received the MRB configuration information.

As shown by reference number 445, the UE may transmit, and the second base station may receive, a request to resume the RRC connection. In some aspects, the UE may transmit the request to resume the RRC connection based at least in part on receiving the indication to resume the RRC connection (e.g., as described in connection with reference number 440). In some aspects, the UE may transmit the request to resume the RRC connection independently from, or in absence of, receiving the indication to resume the RRC connection. For example, the UE may obtain one or more radio channel condition metrics and may transmit the request to resume the RRC connection based at least in part on the radio channel condition metrics.

As shown by reference number 450, the UE may receive, and the second base station may transmit, an indication to enter the RRC inactive state. In some aspects, the second base station may determine whether to release the UE to the inactive state based at least in part on network congestion and/or available resources at the second base station. For example, the second base station may transmit the indication to enter the inactive state based at least in part on a number of UEs connected to the second base station that are configured to receive the multicast service.

Based at least in part on the UE receiving the MRB configuration information indicating one or more MRB configurations, the UE may continue to receive multicast communications via the second cell without first resuming an RRC connection. In this way, the UE may conserve computing, power, network, and/or communication resources that may have otherwise been used to request an RRC connection with the neighbor cell and to establish the RRC connection with the neighbor cell.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with MRB configuration information.

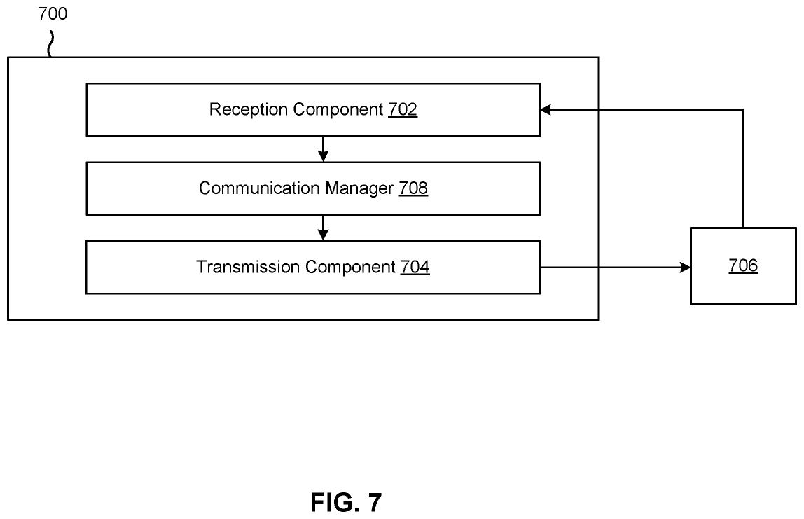

As shown in FIG. 5, in some aspects, process 500 may include receiving, via a first cell, MRB configuration information indicating one or more MRB configurations for receiving multicast communications (block 510). For example, the UE (e.g., using reception component 702, depicted in FIG. 7) may receive, via a first cell, MRB configuration information indicating one or more MRB configurations for receiving multicast communications, as described above.

As further shown in FIG. 5, in some aspects, process 500 may include receiving, via a second cell, a multicast communication based at least in part on an MRB configuration of the one or more MRB configurations (block 520). For example, the UE (e.g., using reception component 702, depicted in FIG. 7) may receive, via a second cell, a multicast communication based at least in part on an MRB configuration of the one or more MRB configurations (e.g., using the MRB configuration or using an associated MRB configuration), as described above.

Process 500 may include additional aspects, such as any single aspect or any combination of aspects described below and/or in connection with one or more other processes described elsewhere herein.

In a first aspect, process 500 includes entering an inactive state before receiving the multicast communication via the second cell.

In a second aspect, alone or in combination with the first aspect, receiving the multicast communication via the second cell comprises receiving the multicast communication via the second cell without first resuming a radio resource control connection in the second cell.

In a third aspect, alone or in combination with one or more of the first and second aspects, process 500 includes transmitting a request to resume radio resource control connection based at least in part on one or more radio channel condition metrics associated with the second cell.

In a fourth aspect, alone or in combination with one or more of the first through third aspects, process 500 includes receiving, via the second cell, an indication to use the MRB configuration for receiving the multicast communication.

In a fifth aspect, alone or in combination with one or more of the first through fourth aspects, receiving the indication comprises receiving the indication via one or more of a system information block, or multicasting control channel signaling.

In a sixth aspect, alone or in combination with one or more of the first through fifth aspects, the indication comprises an additional indication that the second cell is associated with the MRB configuration information.

In a seventh aspect, alone or in combination with one or more of the first through sixth aspects, receiving the MRB configuration information comprises receiving the MRB configuration information via one or more of multicasting control channel signaling, a radio resource control reconfiguration message, or a radio resource control release message.

In an eighth aspect, alone or in combination with one or more of the first through seventh aspects, the first cell is associated with an additional MRB configuration of the one or more MRB configurations, wherein the additional MRB configuration is different from the MRB configuration.

In a ninth aspect, alone or in combination with one or more of the first through eighth aspects, the MRB configuration information indicates the one or more MRB configurations for a multicast radio access network area that includes a first set of cells including the first cell and the second cell, and wherein a broadcast service area associated with the first cell includes a second set of cells including a third cell that is not included in the first set of cells.

In a tenth aspect, alone or in combination with one or more of the first through ninth aspects, process 500 includes receiving an indication that the multicast radio access network is configured to provide a multicast service, within the first set of cells, to UEs in an inactive state.

In an eleventh aspect, alone or in combination with one or more of the first through tenth aspects, the MRB configuration information is associated with receiving multicast communications when in an inactive state, or wherein the MRB configuration information is associated with receiving multicast communications when in an inactive state or an active state.

In a twelfth aspect, alone or in combination with one or more of the first through eleventh aspects, process 500 includes receiving an indication to resume a radio resource control connection to receive the MRB configuration information.

In a thirteenth aspect, alone or in combination with one or more of the first through twelfth aspects, process 500 includes resuming the RRC connection to receive the MRB configuration information, or receiving the multicast communication without resuming RRC connection based at least in part on receiving the MRB configuration prior to receiving the indication to resume the RRC connection.

In a fourteenth aspect, alone or in combination with one or more of the first through thirteenth aspects, process 500 includes receiving an indication of a message type used to communicate the MRB configuration information.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with MRB configuration information.

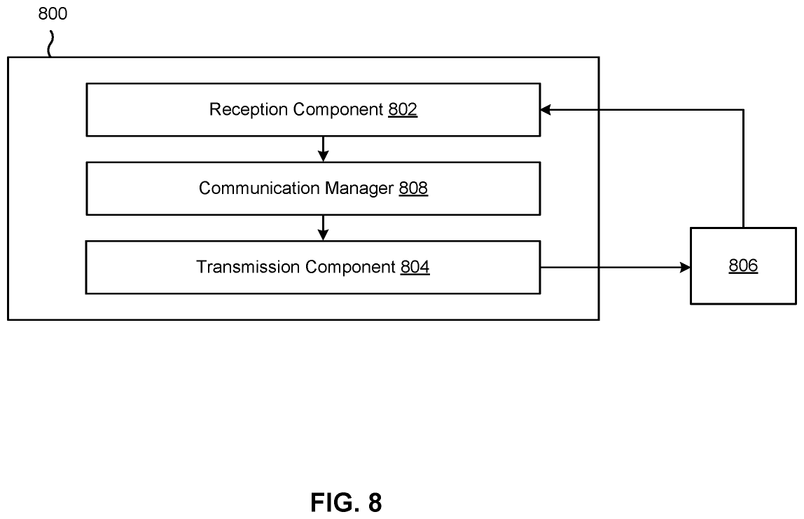

As shown in FIG. 6, in some aspects, process 600 may include transmitting MRB configuration information indicating one or more MRB configurations for receiving multicast communications within a multicast area associated with a set of multiple cells (block 610). For example, the base station (e.g., using transmission component 804, depicted in FIG. 8) may transmit MRB configuration information indicating one or more MRB configurations for receiving multicast communications within a multicast area associated with a set of multiple cells, as described above.

As further shown in FIG. 6, in some aspects, process 600 may include transmitting, to one or more additional base stations associated with the multicast area, an indication to establish an MBS based at least in part on a UE associated with the MBS entering an inactive state (block 620). For example, the base station (e.g., using transmission component 804, depicted in FIG. 8) may transmit, to one or more additional base stations associated with the multicast area, an indication to establish an MBS based at least in part on a UE associated with the MBS entering an inactive state, as described above.

Process 600 may include additional aspects, such as any single aspect or any combination of aspects described below and/or in connection with one or more other processes described elsewhere herein.

In a first aspect, transmitting the indication to establish the MBS service comprises one or more of transmitting the indication via a network entity, or transmitting the indication via a base station to base station link.

In a second aspect, alone or in combination with the first aspect, transmitting the indication via the network entity comprises transmitting an indication that the base station is associated with the multicast RAN area.

In a third aspect, alone or in combination with one or more of the first and second aspects, transmitting MBS configuration information comprises transmitting the MBS configuration information via one or more of radio resource control signaling, or multicasting control channel signaling.

In a fourth aspect, alone or in combination with one or more of the first through third aspects, process 600 includes transmitting an indication of an MRB configuration supported by the base station.

In a fifth aspect, alone or in combination with one or more of the first through fourth aspects, process 600 includes transmitting a multicast communication based at least in part on an MRB configuration of the one or more MRB configurations.

In a sixth aspect, alone or in combination with one or more of the first through fifth aspects, transmitting the multicast communication comprises transmitting the multicast communication based at least in part on a UE associated with the MBS entering the inactive state.

In a seventh aspect, alone or in combination with one or more of the first through sixth aspects, process 600 includes receiving a request to resume a radio resource control connection based at least in part on one or more radio channel condition metrics obtained by the user equipment.

In an eighth aspect, alone or in combination with one or more of the first through seventh aspects, process 600 includes transmitting an indication to use an MRB configuration, of the one or more MRB configurations, for receiving a multicast communication associated with the MBS within a cell associated with the base station.

In a ninth aspect, alone or in combination with one or more of the first through eighth aspects, transmitting the indication comprises transmitting the indication via one or more of a system information block, or multicasting control channel signaling.

In a tenth aspect, alone or in combination with one or more of the first through ninth aspects, the indication comprises an additional indication that the cell is associated with the MRB configuration information.

In an eleventh aspect, alone or in combination with one or more of the first through tenth aspects, transmitting the MRB configuration information comprises transmitting the MRB configuration information via one or more of multicasting control channel signaling, a radio resource control reconfiguration message, or a radio resource control release message.

In a twelfth aspect, alone or in combination with one or more of the first through eleventh aspects, a first MRB configuration for a cell associated with the base station is a different configuration from a second MRB configuration for an additional cell associated with an additional base station of the one or more additional base stations, and wherein the one or more MRB configurations include the first MRB configuration and the second MRB configuration.

In a thirteenth aspect, alone or in combination with one or more of the first through twelfth aspects, the MRB configuration information indicates the one or more MRB configurations for a multicast radio access network area that includes a first set of cells including a first cell associated with the base station and a second cell, and wherein a broadcast service area associated with the first cell includes a second set of cells including a third cell that is not included in the first set of cells.

In a fourteenth aspect, alone or in combination with one or more of the first through thirteenth aspects, process 600 includes transmitting an indication that the multicast radio access network is configured to provide a multicast service, within the first set of cells, to UEs in an inactive state.

In a fifteenth aspect, alone or in combination with one or more of the first through fourteenth aspects, the MRB configuration information is associated with transmitting multicast communications to UEs in an inactive state, or wherein the MRB configuration information is associated with transmitting multicast communications to UEs when in an inactive state or an active state.

In a sixteenth aspect, alone or in combination with one or more of the first through fifteenth aspects, process 600 includes transmitting an indication to resume a radio resource control connection to receive the MRB configuration information.

In a seventeenth aspect, alone or in combination with one or more of the first through sixteenth aspects, process 600 includes receiving, from the UE, a request to resume RRC connection, and transmitting an indication to release the RRC connection based at least in part on the UE receiving the MRB configuration prior to receiving the indication to resume the RRC connection.

In an eighteenth aspect, alone or in combination with one or more of the first through seventeenth aspects, process 600 includes transmitting an indication of a message type used to communicate the MRB configuration information.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a block diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a communication manager 708.

In some aspects, the apparatus 700 may be configured to perform one or more operations described herein in connection with FIGS. 3 and 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described above in connection with FIG. 2. Additionally, or alternatively, one or more components shown in FIG. 7 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described above in connection with FIG. 2. In some aspects, the transmission component 704 may be co-located with the reception component 702 in a transceiver.

The reception component 702 may receive, via a first cell, MRB configuration information indicating one or more MRB configurations for receiving multicast communications. The reception component 702 may receive, via a second cell, a multicast communication based at least in part on an MRB configuration of the one or more MRB configurations.

The communication manager 708 may enter an inactive state before receiving the multicast communication via the second cell.

The transmission component 704 may transmit a request to resume radio resource control connection based at least in part on one or more radio channel condition metrics associated with the second cell.

The reception component 702 may receive, via the second cell, an indication to use the MRB configuration for receiving the multicast communication.

The reception component 702 may receive an indication that the multicast radio access network is configured to provide a multicast service, within the first set of cells, to UEs in an inactive state.

The reception component 702 may receive an indication to resume a radio resource control connection to receive the MRB configuration information.

The communication manager 708 may resume the RRC connection to receive the MRB configuration information.

The reception component 702 may receive the multicast communication without resuming RRC connection based at least in part on receiving the MRB configuration prior to receiving the indication to resume the RRC connection.

The reception component 702 may receive an indication of a message type used to communicate the MRB configuration information.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a block diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a communication manager 808.

In some aspects, the apparatus 800 may be configured to perform one or more operations described herein in connection with FIGS. 3 and 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described above in connection with FIG. 2. Additionally, or alternatively, one or more components shown in FIG. 8 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a demodulator, a MIMO detector, a receive processor, a controller/processor, a memory, or a combination thereof, of the base station described above in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the base station described above in connection with FIG. 2. In some aspects, the transmission component 804 may be co-located with the reception component 802 in a transceiver.

The transmission component 804 may transmit MRB configuration information indicating one or more MRB configurations for receiving multicast communications within a multicast area associated with a set of multiple cells. The transmission component 804 may transmit, to one or more additional base stations associated with the multicast area, an indication to establish an MBS based at least in part on a UE associated with the MBS entering an inactive state.

The transmission component 804 may transmit an indication of an MRB configuration supported by the base station.

The transmission component 804 may transmit a multicast communication based at least in part on an MRB configuration of the one or more MRB configurations.

The reception component 802 may receive a request to resume a radio resource control connection based at least in part on one or more radio channel condition metrics obtained by the user equipment.

The transmission component 804 may transmit an indication to use an MRB configuration, of the one or more MRB configurations, for receiving a multicast communication associated with the MBS within a cell associated with the base station.

The transmission component 804 may transmit an indication that the multicast radio access network is configured to provide a multicast service, within the first set of cells, to UEs in an inactive state.

The transmission component 804 may transmit an indication to resume a radio resource control connection to receive the MRB configuration information.

The reception component 802 may receive, from the UE, a request to resume the RRC connection.

The transmission component 804 may transmit an indication to release the RRC connection based at least in part on the UE receiving the MRB configuration prior to receiving the indication to resume the RRC connection.

The transmission component 804 may transmit an indication of a message type used to communicate the MRB configuration information.

The communication manager 808 may manage communications between the apparatus 800 and the apparatus 806. For example, the communication manager 808 may configure one or more components of the apparatus 800 to form a beam for communication with the apparatus 806. In some aspects, the communication manager 808 may perform one or more determinations, based at least in part on received and/or measured information, for communicating with the apparatus 806.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a user equipment (UE), comprising: receiving, via a first cell, multicast radio bearer (MRB) configuration information indicating one or more MRB configurations for receiving multicast communications; and receiving, via a second cell, a multicast communication based at least in part on an MRB configuration of the one or more MRB configurations.
Aspect 2: The method of Aspect 1, further comprising: entering an inactive state before receiving the multicast communication via the second cell.
Aspect 3: The method of Aspect 2, wherein receiving the multicast communication via the second cell comprises: receiving the multicast communication via the second cell without first resuming a radio resource control connection in the second cell.
Aspect 4: The method of Aspect 2, further comprising: transmitting a request to resume radio resource control connection based at least in part on one or more radio channel condition metrics associated with the second cell.
Aspect 5: The method of any of Aspects 1-4, further comprising: receiving, via the second cell, an indication to use the MRB configuration for receiving the multicast communication.
Aspect 6: The method of Aspect 5, wherein receiving the indication comprises receiving the indication via one or more of: a system information block, or multicast control channel signaling.
Aspect 7: The method of Aspect 5, wherein the indication comprises an additional indication that the second cell is associated with the MRB configuration information.
Aspect 8: The method of any of Aspects 1-7, wherein receiving the MRB configuration information comprises receiving the MRB configuration information via one or more of: multicast control channel signaling, a radio resource control reconfiguration message, or a radio resource control release message.
Aspect 9: The method of any of Aspects 1-8, wherein the first cell is associated with an additional MRB configuration of the one or more MRB configurations, wherein the additional MRB configuration is different from the MRB configuration.
Aspect 10: The method of any of Aspects 1-9, wherein the MRB configuration information indicates the one or more MRB configurations for a multicast radio access network area that includes a first set of cells including the first cell and the second cell, and wherein a broadcast service area associated with the first cell includes a second set of cells including a third cell that is not included in the first set of cells.
Aspect 11: The method of Aspect 10, further comprising: receiving an indication that the multicast radio access network is configured to provide a multicast service, within the first set of cells, to UEs in an inactive state.
Aspect 12: The method of any of Aspects 1-11, wherein the MRB configuration information is associated with receiving multicast communications when in an inactive state, or wherein the MRB configuration information is associated with receiving multicast communications when in an inactive state or an active state.
Aspect 13: The method of any of Aspects 1-12, further comprising: receiving an indication to resume a radio resource control connection to receive the MRB configuration information.
Aspect 14: The method of Aspect 13, further comprising: resuming the radio resource control (RRC) connection to receive the MRB configuration information, or receiving the multicast communication without resuming the RRC connection based at least in part on receiving the MRB configuration prior to receiving the indication to resume the RRC connection.
Aspect 15: The method of any of Aspects 1-14, further comprising: receiving an indication of a message type used to communicate the MRB configuration information.
Aspect 16: A method of wireless communication performed by a base station, comprising: transmitting multicast radio bearer (MRB) configuration information indicating one or more MRB configurations for receiving multicast communications within a multicast area associated with a set of multiple cells; and transmitting, to one or more additional base stations associated with the multicast area, an indication to establish a multicast broadcast service (MBS) based at least in part on a user equipment (UE) associated with the MBS entering an inactive state.
Aspect 17: The method of Aspect 16, wherein transmitting the indication to establish the MBS service comprises one or more of: transmitting the indication via a network entity, or transmitting the indication via a base station to base station link.
Aspect 18: The method of Aspect 17, wherein transmitting the indication via the network entity comprises: transmitting an indication that the base station is associated with the multicast RAN area.
Aspect 19: The method of any of Aspects 16-18, wherein transmitting MBS configuration information comprises transmitting the MBS configuration information via one or more of: radio resource control signaling, or multicast control channel signaling.
Aspect 20: The method of any of Aspects 16-19, further comprising: transmitting an indication of an MRB configuration supported by the base station.
Aspect 21: The method of any of aspects 16-20, further comprising: transmitting a multicast communication based at least in part on an MRB configuration of the one or more MRB configurations.
Aspect 22: The method of Aspect 21, wherein transmitting the multicast communication comprises: transmitting the multicast communication based at least in part on a UE associated with the MBS entering the inactive state.
Aspect 23: The method of any of Aspects 16-22, further comprising: receiving a request to resume a radio resource control connection based at least in part on one or more radio channel condition metrics obtained by the user equipment.
Aspect 24: The method of Aspect 33, further comprising: transmitting an indication to use an MRB configuration, of the one or more MRB configurations, for receiving a multicast communication associated with the MBS within a cell associated with the base station.
Aspect 25: The method of Aspect 24, wherein transmitting the indication comprises transmitting the indication via one or more of: a system information block, or multicast control channel signaling.
Aspect 26: The method of Aspect 24, wherein the indication comprises an additional indication that the cell is associated with the MRB configuration information.
Aspect 27: The method of any of Aspects 16-26, wherein transmitting the MRB configuration information comprises transmitting the MRB configuration information via one or more of: multicast control channel signaling, a radio resource control reconfiguration message, or a radio resource control release message.
Aspect 28: The method of any of Aspects 16-27, wherein a first MRB configuration for a cell associated with the base station is a different configuration from a second MRB configuration for an additional cell associated with an additional base station of the one or more additional base stations, and wherein the one or more MRB configurations include the first MRB configuration and the second MRB configuration.
Aspect 29: The method of any of Aspects 16-28, wherein the MRB configuration information indicates the one or more MRB configurations for a multicast radio access network area that includes a first set of cells including a first cell associated with the base station and a second cell, and wherein a broadcast service area associated with the first cell includes a second set of cells including a third cell that is not included in the first set of cells.
Aspect 30: The method of Aspect 29, further comprising: transmitting an indication that the multicast radio access network is configured to provide a multicast service, within the first set of cells, to UEs in an inactive state.
Aspect 31: The method of any of Aspects 16-30, wherein the MRB configuration information is associated with transmitting multicast communications to UEs in an inactive state, or wherein the MRB configuration information is associated with transmitting multicast communications to UEs when in an inactive state or an active state.
Aspect 32: The method of any of Aspects 16-31, further comprising: transmitting an indication to resume a radio resource control connection to receive the MRB configuration information.
Aspect 33: The method of Aspect 32, further comprising: receiving, from the UE, a request to resume the radio resource control (RRC) connection, and transmitting an indication to release the RRC connection based at least in part on the UE receiving the MRB configuration prior to receiving the indication to resume the RRC connection.
Aspect 34: The method of Aspect 33, further comprising: transmitting an indication of a message type used to communicate the MRB configuration information.
Aspect 35: An apparatus for wireless communication at a device, comprising a processor; memory coupled with the processor; and instructions stored in the memory and executable by the processor to cause the apparatus to perform the method of one or more of Aspects 1-34.
Aspect 36: A device for wireless communication, comprising a memory and one or more processors coupled to the memory, the memory and the one or more processors configured to perform the method of one or more of Aspects 1-34.
Aspect 37: An apparatus for wireless communication, comprising at least one means for performing the method of one or more of Aspects 1-34.
Aspect 38: A non-transitory computer-readable medium storing code for wireless communication, the code comprising instructions executable by a processor to perform the method of one or more of Aspects 1-34.
Aspect 39: A non-transitory computer-readable medium storing a set of instructions for wireless communication, the set of instructions comprising one or more instructions that, when executed by one or more processors of a device, cause the device to perform the method of one or more of Aspects 1-34.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving, via a first cell, multicast radio bearer (MRB) configuration information indicating one or more MRB configurations for receiving multicast communications; and
receiving, via a second cell, a multicast communication based at least in part on an MRB configuration of the one or more MRB configurations.

2. The method of claim 1, further comprising:
entering an inactive state before receiving the multicast communication via the second cell.

3-4. (canceled)

5. The method of claim 1, further comprising:
receiving, via the second cell, an indication to use the MRB configuration for receiving the multicast communication.

6-8. (canceled)

9. The method of claim 1, wherein the first cell is associated with an additional MRB configuration of the one or more MRB configurations,
wherein the additional MRB configuration is different from the MRB configuration.

10. The method of claim 1, wherein the MRB configuration information indicates the one or more MRB configurations for a multicast radio access network area that includes a first set of cells including the first cell and the second cell, and
wherein a broadcast service area associated with the first cell includes a second set of cells including a third cell that is not included in the first set of cells.

11. (canceled)

12. The method of claim 1, wherein the MRB configuration information is associated with receiving multicast communications when in an inactive state, or
wherein the MRB configuration information is associated with receiving multicast communications when in an inactive state or an active state.

13. The method of claim 1, further comprising:
receiving an indication to resume a radio resource control connection to receive the MRB configuration information.

14. (canceled)

15. The method of claim 1, further comprising:
receiving an indication of a message type used to communicate the MRB configuration information.

16. A user equipment (UE) for wireless communication, comprising:
one or more memories; and
one or more processors, coupled to the one or more memories, configured to:
receive, via a first cell, multicast radio bearer (MRB) configuration information indicating one or more MRB configurations for receiving multicast communications; and
receive, via a second cell, a multicast communication based at least in part on an MRB configuration of the one or more MRB configurations.

17. The UE of claim 16, wherein the one or more processors are further configured to:
enter an inactive state before receiving the multicast communication via the second cell.

18. The UE of claim 17, wherein the one or more processors, to receive the multicast communication via the second cell, are configured to:
receive the multicast communication via the second cell without first resuming a radio resource control connection in the second cell.

19. The UE of claim 17, wherein the one or more processors are further configured to:
transmit a request to resume radio resource control connection based at least in part on one or more radio channel condition metrics associated with the second cell.

20. The UE of claim 16, wherein the one or more processors are further configured to:
receive, via the second cell, an indication to use the MRB configuration for receiving the multi cast communication.

21. The UE of claim 20, wherein the one or more processors, to receive the indication, are configured to receive the indication via one or more of:
a system information block, or
multicast control channel signaling.

22. The UE of claim 20, wherein the indication comprises an additional indication that the second cell is associated with the MRB configuration information.

23. The UE of claim 16, wherein the one or more processors, to receive the MRB configuration information, are configured to receive the MRB configuration information via one or more of:
multicast control channel signaling,
a radio resource control reconfiguration message, or
a radio resource control release message.

24. The UE of claim 16, wherein the first cell is associated with an additional MRB configuration of the one or more MRB configurations,
wherein the additional MRB configuration is different from the MRB configuration.

25. The UE of claim 16, wherein the MRB configuration information indicates the one or more MRB configurations for a multicast radio access network area that includes a first set of cells including the first cell and the second cell, and
wherein a broadcast service area associated with the first cell includes a second set of cells including a third cell that is not included in the first set of cells.

26. The UE of claim 25, wherein the one or more processors are further configured to:
receive an indication that the multicast radio access network is configured to provide a multicast service, within the first set of cells, to UEs in an inactive state.

27. The UE of claim 16, wherein the MRB configuration information is associated with receiving multicast communications when in an inactive state, or
wherein the MRB configuration information is associated with receiving multicast communications when in an inactive state or an active state.

28. The UE of claim 16, wherein the one or more processors are further configured to:
receive an indication to resume a radio resource control connection to receive the MRB configuration information.

29. The UE of claim 28, wherein the one or more processors are further configured to:
resume the radio resource control (RRC) connection to receive the MRB configuration information, or
receive the multicast communication without resuming RRC connection based at least in part on receiving the MRB configuration prior to receiving the indication to resume the RRC connection.

30. The UE of claim 16, wherein the one or more processors are further configured to:
receive an indication of a message type used to communicate the MRB configuration information.

31. A method of wireless communication performed by a base station, comprising:
transmitting multicast radio bearer (MRB) configuration information indicating one or more MRB configurations for receiving multicast communications within a multicast area associated with a set of multiple cells; and
transmitting, to one or more additional base stations associated with the multicast area, an indication to establish a multicast broadcast service (MBS) based at least in part on a user equipment (UE) associated with the MBS entering an inactive state.

32. The method of claim 31, wherein transmitting the indication to establish the MBS service comprises one or more of:
transmitting the indication via a network entity, or
transmitting the indication via a base station to base station link.

33. (canceled)

34. The method of claim 31, wherein transmitting MBS configuration information comprises transmitting the MBS configuration information via one or more of:
radio resource control signaling, or
multicast control channel signaling.

35. A base station for wireless communication, comprising:
one or more memories; and
one or more processors, coupled to the one or more memories, configured to:
transmit multicast radio bearer (MRB) configuration information indicating one or more MRB configurations for receiving multicast communications within a multicast area associated with a set of multiple cells; and
transmit, to one or more additional base stations associated with the multicast area, an indication to establish a multicast broadcast service (MBS) based at least in part on a user equipment (UE) associated with the MBS entering an inactive state.

36. The base station of claim 35, wherein the one or more processors, to transmit the indication to establish the MBS service, are configured to:
transmit the indication via a network entity, or
transmit the indication via a base station to base station link.

37. The base station of claim 36, wherein the one or more processors, to transmit the indication via the network entity, are configured to:
transmit an indication that the base station is associated with the multicast RAN area.

38. The base station of claim 35, wherein the one or more processors, to transmit MBS configuration information, are configured to transmit the MBS configuration information via one or more of:
radio resource control signaling, or
multicast control channel signaling.
